(19) United States
(12) Patent Application Publication
(10) Pub. No.: US 2004/0017860 A1
(43) Pub. Date: Jan. 29, 2004

(54) Multiple antenna system for varying transmission streams

(76) Inventor: Jung-Tao Liu, Randolph, NJ (US)

Correspondence Address: Docket Administrator (Rm. 3J-219), Lucent Technologies Inc., 101 Crawfords Corner Road, Holmdel, NJ, 07733-3030, US

(21) Appl. No.: 10/207,637

(22) Filed: Jul. 29, 2002

(51) Int. Cl. H04L 27/04

(52) U.S. Cl. 375/299

(57) ABSTRACT

A method of communication using one or more antennas. The method includes varying at least one of a plurality of transmission streams to be loaded onto an antenna. Each transmission stream may be varied in response to the channel conditions corresponding with the relevant antenna. Varying one or more transmission streams may be realized by modulating and/or rate matching each relevant transmission stream in accordance with the air interface characteristics of the relevant antenna. The rate of the stream may be adjusted by puncturing at least one bit from the transmission stream and/or filling the transmission stream with in at least one bit.

### BACKGROUND OF THE INVENTION

I. Field of the Invention

The present invention relates to wireless communications, and more particularly to a multiple antenna system.

II. Description of the Related Art

It has been observed that traditional Multiple-Input, Multiple-Output (“MIMO”) antenna systems do not optimally perform when channel characteristics for each individual transmission path are relatively different. This non-optimal performance has been measured by packet error rates and system throughput. Presently, these MIMO antenna systems transmit equal amount of bits on each antenna using the same modulation, irrespective of different capacities of each of the channels in the system. One known approach utilizes aggregate capacity information of the MIMO antenna system—or the equivalent thereof—for determining a suitable modulation and information rate to be used for each transmit antenna. For the purposes of the present disclosure, information rate may be defined as the number of information bits that can be transmitted using a particular transmission path over a given amount of time.

While using aggregate capacity information provides for a number of performance improvements, it is not ideal. Fundamentally, the aggregate capacity of each of the channels in the MIMO antenna system may not reflect the channel condition and capacity that each transmit antenna can support. Consequently, a need exists for a MIMO antenna system reflecting the channel condition and capacity that each transmit antenna may support.

### SUMMARY OF THE INVENTION

The present invention provides a method for varying at least one transmission stream of plurality in response to the condition of the channel over which the varied transmission stream may be transmitted. For the purposes of the present invention, a plurality of transmission streams may be formed from a number of packets and/or bits derived from an information stream, wherein each transmission stream may comprise data, bits, symbols and/or packets.

In an embodiment of the present invention, the modulation of each transmission stream may be varied. Each transmission stream is loaded onto a transmission path having at least one antenna. Each transmission path also may comprise a modulator for varying the corresponding transmission stream in accordance with the condition of the channel of that transmission path. The condition of each channel may be ascertained from determining the air interface characteristics of the antenna corresponding with that channel of the particular transmission path.

In another embodiment of the present invention, the rate of each transmission stream may be varied. For the purposes of the present invention, rate matching may be defined as matching an information rate of a transmission path to the air interface characteristics of that transmission path by filling in one or more bits into the corresponding transmission stream and/or puncturing out one or more bits from the corresponding transmission stream. Each transmission stream is loaded onto a transmission path having at least one antenna. Each transmission path also may comprise a rate matching device for varying the corresponding transmission stream in accordance with the condition of the channel of that transmission path. The condition of each channel may be ascertained from determining the air interface characteristics of the antenna corresponding with that channel of the particular transmission path. In one example, each rate matching device may puncture at least one bit from the relevant transmission stream and/or fill the transmission stream with at least one bit. By puncturing and/or filling, the size of each transmission stream, consequently, may be controlled, and thusly, the capacity of each channel may be maintained and/or desirably modified.

### BRIEF DESCRIPTION OF THE DRAWINGS

The present invention will be better understood from reading the following description of non-limiting embodiments, with reference to the attached drawings, wherein below:

FIG. 1 depicts known multiple antenna system;

FIG. 2 depicts an embodiment of the present invention;

FIG. 3 depicts another embodiment of the present invention; and

FIG. 4 depicts another embodiment of the present invention.

It should be emphasized that the drawings of the instant application are not to scale but are merely schematic representations, and thus are not intended to portray the specific dimensions of the invention, which may be determined by skilled artisans through examination of the disclosure herein.

### DETAILED DESCRIPTION

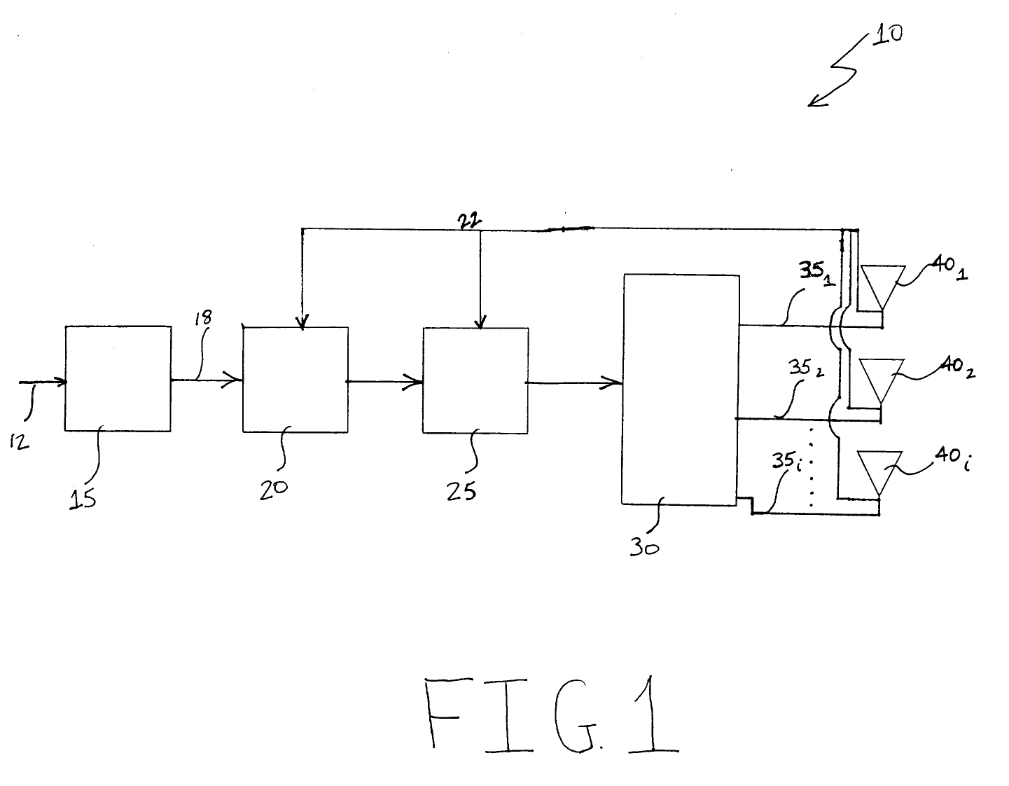

As detailed hereinabove, various multiple-input, multiple-output (“MIMO”) antenna systems are known. One known MIMO antenna system 10 is illustrated in FIG. 1. MIMO antenna system 10 receives data blocks 12 as an input. More particularly, system 10 includes a device 15 for receiving data blocks 12. Device 15 converts each received data block into at least one information stream 18. An information stream, for the purposes of the present invention, may be defined as a number of packet and/or bits derived from an initial block of data.

System 10 self-determines its aggregate capacity. More particularly, system 10 determines the collective air interface characteristics 22 of transmit antennas, 40₁, 40₂ through 40ᵢ. This determination may be achieved by various means known in the art. In one approach, the capacity of the collective transmit antennas is determined using a test signal transmitted from system 10 to a wireless user and re-transmitted back to system 10. From this exchange, aggregate air interface characteristics 22 of system 10 may be ascertained.

Thereafter, the size of each information stream may be modified to maintain the aggregate capacity of system 10 at a steady state. To this end, multiple antenna system 10 includes a device 20 for performing rate matching in response to the established aggregate air interface characteristics 22 of system 10. Device 20 receives each information stream 18, one at a time. As a result, device 20 may puncture one or more bits from each stream. Alternatively, device 20 may fill each information stream 18 with one or more additional bits. By puncturing or filling each information stream 18, the size of each information stream, consequently, may be controlled, and thusly, the aggregate capacity of system 10 may be maintained.

Once rate matched, each information stream is processed by a modulator 25. Modulator 25 modulates the contents of each information stream. More particularly, modulator 25 generates symbols from each information stream encoded according a scheme selected in response to aggregate air interface characteristics 22 of system 10. Consequently, the symbols generated from an information stream by modulator 25 may vary in accordance with the determined aggregate capacity of system 10.

The symbols generated by modulator 25 are correspondingly fed into a demultiplexer 30. Demultiplexer 30 distributes the generated symbols for each information stream equally amongst each transmission path, 35₁, 35₂ through 35ᵢ. Thusly, transmission paths, 35₁, 35₂ through 35ᵢ, each receive an equal number of symbols, which are directed to a corresponding transmit antenna, 40₁, 40₂ through 40ᵢ, for subsequent transmission. For the purposes of the present invention, the parceling of the information stream amongst transmission paths, 35₁, 35₂ through 35ᵢ, creates a number of transmission streams corresponding with the number of paths. In the illustrated example of FIG. 1, each transmission stream comprises a group of transmission symbols. It will be apparent to skilled artisans, however, that each transmission stream may merely comprises a number of packets and/or bits derived from an information stream.

It is becoming increasing apparent that for certain applications MIMO antenna system 10 of FIG. 1 may not offer optimal performance when channel characteristics for each individual transmission path are relatively different. System 10 may not support the most advantageous MIMO operation, as measure by packet error rates and/or throughput. This non-optimal performance may be attributed to the recognition that the capacities of each of the channels associated with system 10 may differ from channel to channel. More particularly, rate matching device 20 rate matches the information stream and/or modulator 25 modulates the information stream each in response to the aggregate capacity of the entire system 10. Thusly, neither rate matching device 20 nor modulator 25 considers the individual capacity of each channel of the entire system 10. By exclusively considering the aggregate capacity to determine the suitable rate matching and/or modulation employed, the packet error rate and/or throughput of system 10 may not operate optimally.

To overcome the limitations of system 10 of FIG. 1, the present invention varies one or more transmission streams to be loaded onto one or more antennas. More particularly, each transmission stream may be modified in response to the individual capacity of that transmission stream's associated antenna. In considering the individual capacities of each channel, the present invention may also vary the Walsh code employed in conjunction with each transmission stream. Moreover, the present invention enables the transmit time interval (“TTI”) of each transmission stream to be varied in accordance with the individual capacity of each channel.

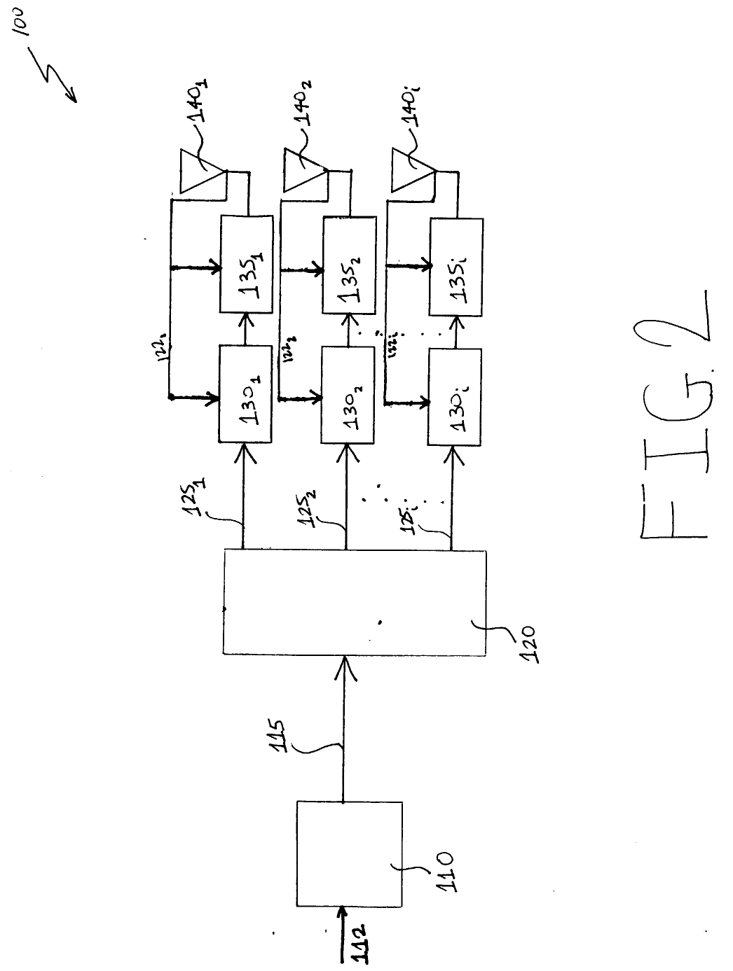

Referring to FIG. 2, a first embodiment of the present invention is illustrated. More particularly, a MIMO antenna system 100 is depicted for varying at least one transmission stream in response to the individual capacity of that transmission stream's associated antenna. System 100 includes a device 110 for receiving data blocks 112. Device 110 converts each received data block into at least one information stream 115. In one example, device 110 comprises a cyclic redundancy checker.

To vary at least one transmission stream in response to the individual capacity of that transmission stream's associated antenna, the condition of each of channel needs to be determined. The condition and capacity of each channel may be ascertained from the individual air interface characteristics, 122₁, 122₂ through 122ᵢ, of each transmit antenna, 140₁, 140₂ through 140ᵢ. These individual air interface characteristics, 122₁, 122₂ through 122ᵢ, may be derived using various techniques, including a feedback mechanism between each transmitting antenna of system 100 and the one or more wireless units interacting with system 100. In single antenna systems, it is known to use a channel quality indicator may be fedback to the transmitting system over a control channel. The channel quality in such system is based on the average received signal-to-noise ratio calculated at a wireless unit. In one example, the air interface characteristics may each be reduced to a vector of propagation coefficients. In another example, the air interface characteristics may be represented by a vector of received signal-to-noise ratios for each transmission path.

Each information stream 115 is fed into a demultiplexer 120. Demultiplexer 120 demultiplexes each information stream 115 to create a plurality of transmission streams. Demultiplexer 120 supports a plurality of transmission paths, 125₁, 125₂ through 125ᵢ, by creating the corresponding plurality of transmission streams. Thusly, each transmission path comprises a transmission stream. It should be noted that, in one example, the transmission streams, as demultiplexed from a received information stream, might each comprise an equal number of bits. However, it will be apparent to skilled artisans that demultiplexer 120 may weigh each transmission path differently such that the distribution of demultiplexed bits forms transmission streams of differing bit lengths relative to each other. In the later exemplary scenario, the weighting of each transmission path by demultiplexer 120 and the distribution of demultiplexed bits may be influenced by air interface characteristics of each transmit antenna.

Once transmission paths, 125₁, 125₂ through 125ᵢ, are defined from information stream 115 by demultiplexer 120, each transmission stream is fed into a corresponding rate matching device, 130₁, 130₂ through 130ᵢ. Each rate matching device may alter the information rate of the transmission stream, in response to the air interface characteristics of the antenna associated therewith. If, for example, the air interface characteristics show a relatively low attenuation pattern, then each rate matching device may fill the corresponding transmission stream with one or more additional bits to enlarge the number of bits to be transmitted and maintain a particular transmission rate. Conversely, should the air interface characteristics show a relatively high attenuation pattern, each rate matching device might puncture one or more bits from the corresponding transmission stream to lessen the number of bits to be transmitted. By puncturing or filling, the size of each transmission stream, consequently, may be controlled, and thusly, the capacity of each channel within system 100 may be maintained and/or desirably modified.

Once rate matched, each transmission stream is then processed by a corresponding modulator, 135₁, 135₂ through 135ᵢ. Each modulator modulates the contents of the received transmission stream. More particularly, each modulator generates symbols from each transmission stream encoded according a scheme selected in response to the received air interface characteristics of the antenna corresponding with associated transmission path. Consequently, the symbols generated from any transmission stream may be varied in accordance with the channel condition of the corresponding antenna and that antenna's air interface characteristics. Once rate matched and modulated, the transmission streams associated each transmission path are fed into a corresponding transmit antenna, 140₁, 140₂ through 140ᵢ, for subsequent transmission.

In one example, the channel condition is represented by the capacity for each transmission path, or equivalently, the number of information bits per second per hertz. Once the capacity for each transmission path is known at the transmitter, the type of modulation scheme may be selected from a pre-determined set of supported modulation schemes in the system. Each modulation scheme converts n bits from a relevant transmission stream into a symbol. After the modulation scheme is selected, the rate matching operation—e.g., the amount of bits to be filled or punctured from the transmission stream—may be determined from the capacity and the type of modulation scheme selected.

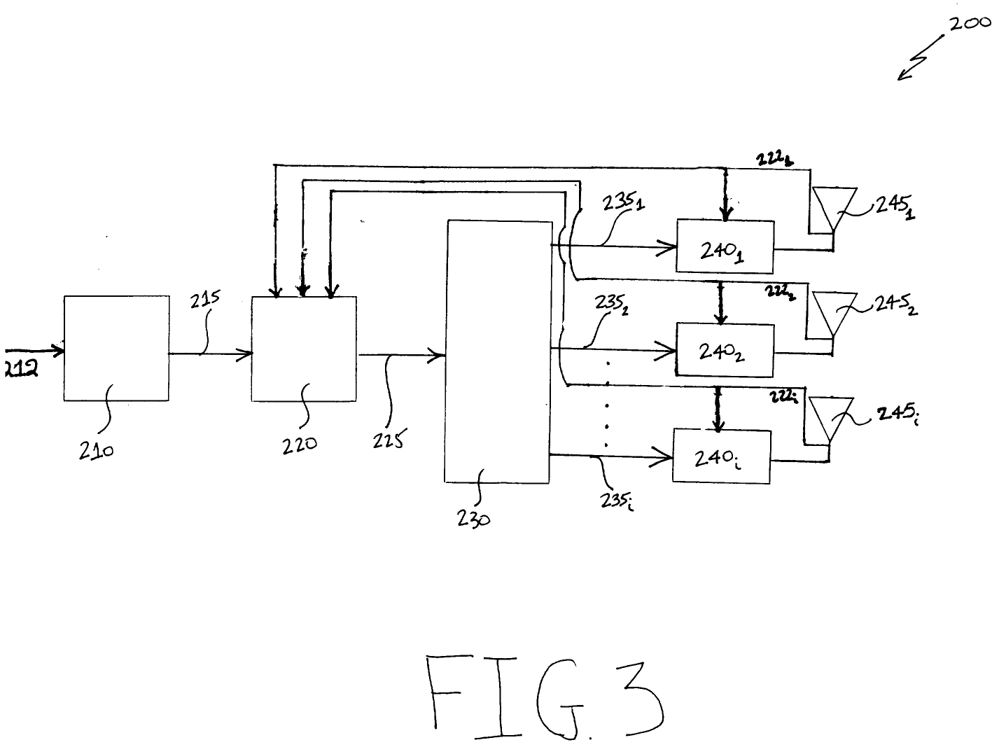

Referring to FIG. 3, another embodiment of the present invention is illustrated. More particularly, a MIMO antenna system 200 is depicted for varying at least one transmission stream in response to the individual capacity of that transmission stream's associated antenna. System 200 includes a device 210 for receiving data blocks 212. Device 210 converts each received data block into at least one information stream 215. In one example, device 210 comprises a cyclic redundancy checker.

As detailed hereinabove, the condition of each of channel needs to be determined to vary at least one transmission stream in response to the individual capacity of that transmission stream's associated antenna. The condition and capacity of each channel may be ascertained from the individual air interface characteristics, 222₁, 222₂ through 222ᵢ, of each transmit antenna, 245₁, 245₂ through 245ᵢ. These individual air interface characteristics, 222₁, 222₂ through 222ᵢ, may be derived using various techniques, including a feedback mechanism between each transmitting antenna of system 200 and the one or more wireless units interacting with system 200. In one example, the air interface characteristics may each be reduced to a vector of propagation coefficients. In another example, the air interface characteristics may be represented by a vector of received signal-to-noise ratios for each transmission path.

Each information stream 215 is fed initially fed into a rate matching device 220. Rate matching device 220 may alter the size of the information stream for subsequent transmission, in response to the air interface characteristics of each antenna in system 200. If, for example, the air interface characteristics of one or more antennas show a relatively low attenuation pattern, then each rate matching device may fill a portion of the information stream, before being converted to an transmission stream, with one or more additional bits to enlarge the number of bits to be transmitted and maintain a particular transmission rate. Conversely, should the air interface characteristics of one or more antennas show a relatively high attenuation pattern, rate matching device 220 might puncture one or more bits from the information stream, before being converted to a transmission stream, to lessen the number of bits to be transmitted. By puncturing or filling the information stream 220, the size of each subsequently formed transmission stream, consequently, may be controlled, and thusly, the capacity of each channel within system 200 may be maintained and/or desirably modified.

Rate matched information stream 225 is thereafter fed into a demultiplexer 230. Demultiplexer 230 demultiplexes the rate matched information stream to create a plurality of transmission streams. Demultiplexer 230 supports a plurality of transmission paths, 235₁, 235₂ through 235ᵢ, by creating the corresponding plurality of transmission streams. Thusly, each transmission path comprises a transmission stream. It should be noted that the length of any of the transmission streams, as demultiplexed from a rate matched information stream, might be also varied by demultiplexer 230 in accordance with the air interface characteristics of the corresponding antenna. Consequently, the distribution of bits, for example, between each of the transmission paths may be weighted in an unequal manner as a result of the air interface characteristics of each of the transmit antennas.

Subsequently, each transmission stream is processed by a corresponding modulator, 240₁, 240₂ through 2405ᵢ. Each modulator modulates the contents of the received transmission stream, thereby generating encoded symbols. More particularly, each modulator generates symbols from each transmission stream encoded according a scheme selected in response to the received air interface characteristics of the antenna corresponding with associated transmission path. Once modulated, each transmission stream is fed into a corresponding transmit antenna, 245₁, 245₂ through 245ᵢ, for subsequent transmission.

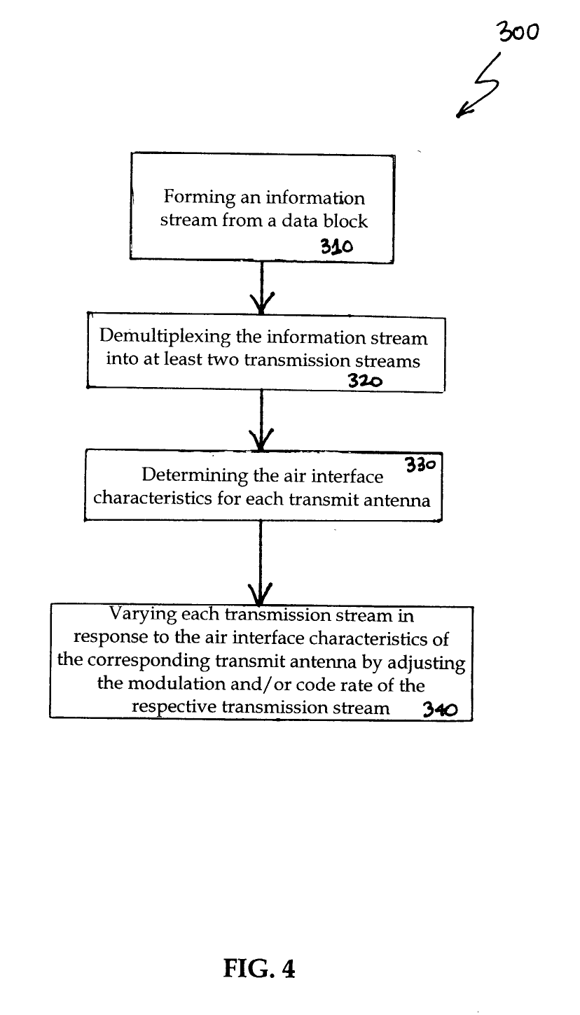

Referring to FIG. 4, a flow chart depicting one embodiment of the present invention is illustrated. More particularly, a method (300) is depicted for varying one more transmission streams in response to the individual capacity—as determined by the air interface characteristics—of that transmission stream's associated antenna. For the purposes of the present invention, the term stream(s) refers to datum, data, a bit(s), a symbol(s), a packet(s) and/or a combination of data, bits, symbols and/or packet(s).

Initially, a data block is received and at least one information stream is created (310). The data block may have been processed through a cyclic redundancy checking mechanism. Alternatively, the information stream may be created as a result of performing a cyclic redundancy checking operation.

Thereafter, the created information stream is demultiplexed into at least two transmission streams (320). Each transmission stream has a transmission path associated therewith. Likewise, a transmit antenna is associated with each transmission path. In one example, the transmission streams may have an equal or unequal number of bits within a given time interval at this point in the method.

To vary at least one of the transmission streams, the condition and capacity of each channel needs to be ascertained (330). More particularly, the condition and capacity of each channel may be determined from the individual air interface characteristics of that each channel's corresponding transmit antenna. As noted hereinabove, these individual air interface characteristics may be derived using various techniques.

With the air interface characteristics of each of the channels established, the method then may vary at least one of the transmission streams (340). More particularly, each transmission stream may be varied in response to the air interface characteristics of the corresponding antenna from which it is to be transmitted. This step of varying may comprise modulating and/or rate matching the one or more transmission streams in response to the air interface characteristics of the antenna corresponding with that transmission stream. The step of rate matching may incorporate the steps of puncturing one or more bits from the transmission stream and/or filling the transmission stream with in one or more bits based on the relevant air interface characteristics. It should be noted that the step of varying may also include the step of modifying the transmit time interval (“TTI”) in response to the air interface characteristics of the corresponding antenna from which it is to be transmitted. Similarly, the step of varying may further comprise the step of varying Walsh code used with one or more transmission streams in response to the relevant air interface characteristics. As a consequence of these varying steps, the transmission streams may have an equal or unequal number of bits within a given time interval.

In an example of the present invention, a MIMO antenna system using an M-receive, N-transmit arrangement may be employed in conjunction with the structures and methods detailed hereinabove. After receiving metrics from a receiver, a transmitter computes the modulation and rate for rate matching based on the received metrics. For a given M×N estimated channel matrix

$$H = [ \begin{matrix}{h}_{11} & ⋯ & {h}_{N1} \\ ⋮ & ⋰ & ⋮ \\ {h}_{1 M} & ⋯ & {h}_{NM}\end{matrix} ]$$

where hⱼᵢs' are i.i.d. complex Gaussian random variables, the feedback metric is a N-tuple vector with the ith element corresponding to the channel quality for the ith transmitted antenna. Each element, denoted as Cᵢ, should be proportional to the product of the number of bits in a modulated symbol and the effective rate for the ith antenna.

For a given realization of channel matrix H, the transmission follows the following sequence. After obtaining channel matrix H from the channel estimator, the receiver computes the metric regarding the channel condition for each individual transmit antenna. These resulting metrics form an N-tuple vector, denoted as [C₁, C₂, . . . , C_{N} ], with each element proportional to the product of N_{bps,I} and R_{eff,i}, where N_{bps,i} is the number of bit per symbol dictated by the type of modulation chosen for the ith antenna and R_{eff,i} is the effective rate for the ith transmit antenna. The N-tuple vector is then quantized and fedback to the transmitter.

Thereafter, the transmitter selects the number of Walsh codes (i.e. N_{Walsh,i}) available for transmission for the ith antenna as well as the length of the transmission time interval, denoted as TTI_{sec,i} for the ith antenna, according to the network resources. It should be noted that the number of Walsh codes does not have to be the same for each antenna. If, however, both N_{Walsh,i} and TTI_{sec,i} are equal for all i=1, . . . , N, the transmitter selects the modulation (e.g., N_{bps,i}) and the effective rate (e.g., R_{eff,i}) for each transmit antenna based on Cᵢ, the channel condition for the ith transmit antenna. Subsequently, the transmitter computes the number of information bits—an integer multiple of some pre-defined code block sizes—that may be transmitted based on the following equation:

$${N}_{code\_block , i} = ⌊ \frac{{N}_{Walsh} * {N}_{bps , i} * {R}_{eff , i}}{SF * {N}_{bpcb}} * {TTI}_{sec} * {R}_{chip} ⌋ , ∀ i = 1 , … , N$$

where N_{code}_{_{—}}_{block,i} is the number of information code blocks can be supported on the ith transmit antenna, N_{Walsh} is the number of Walsh code for each transmit antenna, N_{bps,i} is the number of bit per symbol dictated by the type of modulation chosen for the ith antenna, R_{eff,i} is the effective rate for the ith transmit antenna, SF is the spreading factor, N_{bpcb} is the number of information bits per code block, TTI_{sec} is the transmission time interval in seconds; R_{chip} is the chip rate, └*┘ denotes the nearest integer that is less than or equal to “*” symbol.

From the above mathematical expressions, the total information bits that may be transmitted for the given H may be determined using the following equation:

$${N}_{Info\_bits} = {\sum }_{i = 1}^{N} {N}_{code\_block , i} * {N}_{bpcb} , ∀ i = 1 , … , N$$

where N_{Info}_{_{—}}_{bits} is the total number of information bits transmitted, and N_{code}_{_{—}}_{block,i} is the number of information code blocks can be supported on the ith transmit antenna. The transmitter encodes the N_{Info}_{_{—}}_{bits} into N_{c}=n*N_{Info}_{_{—}}_{bits} coded bits using any type of channel coding schemes. Various channel coding schemes may be employed, including Turbo code, convolutional code, and Block codes, such as BCH and Reed Solomon code, for example. Thereafter, the coded bits are interleaved and distributed to the N transmit antennas. The number of coded bits to be distributed to the ith antenna is N_{code}_{_{—}}_{block,i} *N_{bpcb}, for i=1, . . . , N. The effective rate for each antenna may be computed using the following equation:

$${\overline{R}}_{eff , i} = \frac{SF * {N}_{bpcb} * {N}_{code\_block , i}}{{N}_{Walsh} * {N}_{bps , i} * {TTI}_{sec} * {R}_{chip}} , ∀ i = 1 , … , N$$

Based on the effective rates computed, the bits on each antenna are punctured or repeated, separately. Subsequently, the punctured or repeated coded bits are modulated on each antenna according to N_{bps,i}. The modulated symbols are then spread over the number of Walsh codes on each antenna and the Walsh coded sequences are added together to form a CDMA channel. Finally, the result is transmitted over the RF front end.

At the receiver, information on the transmit encoder packet format (e.g., modulations and effective rates, etc), number of Walsh codes, the length of TTIs for each antenna from the downlink control channel is initially collected. Alternatively, the receiver may compute the encoder packet formats from the information it sends back to the transmitter several time slots ago, in place of receiving the encoder packet formats from the control channel. After dispreading and Rake combining, each received symbols is demodulated and depunctured and/or repeated-decoded based on the encoder packet format received on the control channel. Finally, the received information from the antennas are multiplexed, deinterleaved, and then decoded to derive the original information bits.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Consequently, the method, system and portions thereof and of the described method and system may be implemented in different locations, such as the wireless unit, the base station, a base station controller, a mobile switching center and/or a radar system. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention It is therefore contemplated that the appended claims will cover any such modifications or embodiments as fall within the true scope of the invention.

1. A method of communication comprising:
varying at least one of a plurality of transmission streams to be loaded onto at least one of a plurality of antennas in response to a channel condition.

2. The method of claim 1, wherein the channel condition comprises air interface characteristics of the antenna corresponding with the at least one transmission stream.

3. The method of claim 2, wherein the step of varying at least one of a plurality of transmission streams comprises:
receiving the air interface characteristics of the at least one antenna of the plurality.

4. The method of claim 2, the step of varying at least one of a plurality of transmission streams comprises:
varying a transmit time interval and/or a Walsh code for each transmission stream in response to the air interface characteristics of the antenna corresponding with the at least one transmission stream.

5. The method of claim 2, wherein the step of varying at least one of a plurality of transmission streams comprises:
modulating and/or rate matching the at least one transmission stream in response to the air interface characteristics of the antenna corresponding with the at least one transmission stream.

6. The method of claim 5, wherein the at least one transmission stream is loaded onto at least one antenna of a multiple antenna system, and the modulating and/or the rate matching is varied in response to the air interface characteristics of the antenna corresponding with the at least one transmission stream.

7. The method of claim 4, wherein the plurality of transmission streams each comprise an equal number of bits within a time period, at least before the step of varying at least one of a plurality of transmission streams.

8. The method of claim 4, wherein the step of rate matching the at least one transmission stream comprises:
puncturing at least one bit from the at least one transmission stream and/or filling the at least one transmission stream with in at least one bit in response to the air interface characteristics of the corresponding antenna.

9. The method of claim 8, wherein the plurality of transmission streams each comprise an unequal number of bits within a time period, at least after the step of modulating and/or rate matching of the at least one transmission stream.

10. A method of communication comprising:
forming at least two transmission streams from a plurality of bits; and
varying at least one of the transmission streams in response to a channel condition corresponding with at least one antenna of a multiple antenna system.

11. The method of claim 10, wherein the channel condition comprises air interface characteristics of the at least one antenna corresponding with the at least one transmission stream.

12. The method of claim 11, further comprising:
receiving the air interface characteristics for the at least one antenna of the plurality.

13. The method of claim 11, the step of varying at least one of a plurality of transmission streams comprises:
varying a transmit time interval and/or a Walsh code for each transmission stream in response to the air interface characteristics of the antenna corresponding with the at least one transmission stream.

14. The method of claim 11, further comprising:
loading each varied transmission stream onto the at least one antenna.

15. The method of claim 11, wherein the step of varying at least one of the transmission streams comprises:
modulating and/or rate matching the at least one transmission stream in response to the air interface characteristics of the antenna corresponding with the at least one transmission stream.

16. The method of claim 15, wherein the modulating and/or the rate matching is varied in response to the air interface characteristics of the antenna corresponding with the at least one transmission stream.

17. The method of claim 16, wherein each transmission stream of the plurality comprises an equal number of bits within a time period, at least before the step of varying at least one of a plurality of transmission streams.

18. The method of claim 16, wherein the step of rate matching the at least one transmission stream comprises:
puncturing at least one bit from the at least one transmission stream and/or filling the at least one transmission stream with in at least one bit in response to the air interface characteristics of the antenna corresponding with the at least one transmission stream.

19. The method of claim 18, wherein each transmission stream comprises an unequal number of bits within a time period, at least after the step of modulating and/or rate matching of the at least one transmission stream.

20. A communication system comprising:
a demultiplexer for forming at least two transmission streams from an information stream;
at least two transmission paths, each transmission path comprising:
an antenna having air interface characteristics; and
a modulator for modulating the respective transmission stream in response to the air interface characteristics of the antenna corresponding with the respective transmission stream; and
a rate matcher for rate matching the information stream in response the air interface characteristics of each antenna and/or for rate matching each transmission stream in response to the air interface characteristics of the antenna corresponding with the respective transmission stream.
